(19) United States
(12) Patent Application Publication
(10) Pub. No.: US 2011/0129668 A1
(43) Pub. Date: Jun. 2, 2011

(54) ORGANIC-INORGANIC HYBRID NANOFIBER FOR THERMOELECTRIC APPLICATION AND METHOD OF FORMING THE SAME

(75) Inventors: Tae Hyoung ZYUNG, Daejeon (KR); Moon Gyu JANG, Daejeon (KR); Su Jae LEE, Daejeon (KR); Young Sam PARK, Daejeon (KR); Young Hoon HYUN, Seoul (KR)

(73) Assignee: ELECTRONICS AND TELECOMMUNICATIONS RESEARCH INSTITUTE, Daejeon (KR)

(21) Appl. No.: 12/958,038

(22) Filed: Dec. 1, 2010

(30) Foreign Application Priority Data
Dec. 2, 2009 (KR) 10-2009-0118257

(51) Int. Cl. D01F 8/00; B29C 47/04; D01F 1/09; H01B 1/12; H01B 1/02; B82Y 40/00; B82Y 30/00

(52) U.S. Cl. 428/401; 264/104; 252/500; 252/519.33; 977/811; 977/762

(57) ABSTRACT

Provided is an organic-inorganic hybrid nanofiber including an inorganic semiconductor material in a nanoparticle or nanocrystal state, and a conductive polymer including the inorganic semiconductor material and having a lower thermal conductivity than the inorganic semiconductor material. The inorganic semiconductor material and the conductive polymer are arranged in a composite material type to have a thermoelectric property. Thus, the organic-inorganic hybrid nanofiber can be applied to a low-priced thermoelectric device having relatively high thermoelectric conversion efficiency.

### CROSS-REFERENCE TO RELATED APPLICATION

This application claims priority to and the benefit of Korean Patent Application No. 10-2009-0118257, filed Dec. 2, 2009, the disclosure of which is incorporated herein by reference in its entirety.

### BACKGROUND

1. Field of the Invention

The present invention relates to an organic-inorganic hybrid nanofiber, and more particularly, to a low-priced organic-inorganic hybrid nanofiber having a highly effective thermoelectric property, and a method of forming the same.

2. Discussion of Related Art

Recently, as oil energy rises sharply in response to the gradual exhaustion of energy resources, there are increasing demands for development of new energy resources and development of alternative energy or clean energy from carbon-based energy sources which are the main culprit of global warming, which causes abnormally high temperatures, for example.

Solar energy, which has drawn the most attention as clean energy, is popular because it can be provided unlimitedly and there is no loyalty for the energy resource. However, development of energy using other renewable energy such as wind power, tidal power, or geothermal heat is not globally progressing.

However, the solar energy or renewable energy described above has not been realized in a small package, and thus may be inappropriate to apply to electronic communication devices or parts such as a mobile phone, a laptop computer, or an RFID.

To produce renewable or clean energy suitable for electronic communication devices, the energy should be contained in a small package, and should be able to provide sufficient power though being realized in a small package. However, there is unfortunately no energy resource capable of meeting such conditions. Though fuel cells or bio cells are being studied, they still have problems in stability and reproducibility.

However, thermoelectric producing technology for producing electrical energy from surrounding thermal energy such as bio-heat, that is, heat from a human body or solar heat, is suitable for miniaturization, application to IT devices needing a small amount of power, and, in some cases, prolonging of a lifespan of the devices to be used by providing a suitable amount of power that is needed in an emergency.

Materials for generating thermoelectric energy which have been used so far include a compound material of bismuth (Bi) and telluride (Te). which is the most frequently used. In addition, a compound formed of an atom such as ytterbium (Yb), lead (Pb), cesium (Cs), or silicon (Si), and Te or germanium (Ge) in various compositions has been widely studied as such a material.

However, these inorganic materials have the following problems: First, the materials are generally heavy metals, which have adverse effects on environments. Second, the materials have high synthesis energy such that they have various compositions and necessarily have a structure such as a superlattice. Third, the materials need high energy in module manufacture. Finally, it is difficult to separate and regenerate the materials.

To avoid such problems, methods of using a conductive polymer prepared in a simple process at relatively low cost with low synthesis and production energy from sufficient resources are on the rise. Further, these methods have low thermal conductivity, but still have a problem of low electric conductivity.

In very recent days, theoretical study results have reported that conversion efficiency can be increased using a silicon nanowire, and a material such as graphene can be converted at a very high efficiency. A nano-structure material can disperse phonons having middle or higher wavelengths, which can reduce thermal conductivity caused by a lattice. Thus, there have also been studies in which a material having a Bi₂Te₃/Sb₂Te₃ superlattice structure has been developed, and a silicon nanowire has been applied to a thermoelectric device.

However, the inorganic materials described above are heavy metals or consume high energy such as a high temperature in a process. Therefore, an approach to a new thermoelectric material and a low-priced process to develop it is required to develop a thermoelectric material having a very low thermal conductivity in order to overcome the disadvantages of the thermoelectric property of the conventional inorganic material and have a high ZT value.

### SUMMARY OF THE INVENTION

The present invention is directed to an organic-inorganic hybrid nanofiber which can be applied to a thermoelectric device formed in a nano fiber by hybridizing an organic material having low thermal conductivity with an inorganic material having very high electric conductivity, and a method of forming the same.

One aspect of the present invention provides an organic-inorganic hybrid nanofiber, including: an inorganic semiconductor material in a nanoparticle or nanocrystal state; and a conductive polymer including the inorganic semiconductor material and having a lower thermal conductivity than the inorganic semiconductor material. Here, the inorganic semiconductor material and the conductive polymer are arranged in a composite material type to have a thermoelectric property.

The conductive polymer may include a plurality of the inorganic semiconductor materials, which may be spaced a predetermined distance apart from each other.

The inorganic semiconductor material may be selected from the group consisting of Si, SiGe, Bi, and Sb-based alloys.

The conductive polymer may be selected from the group consisting of polythiophene, poly(p-phenylene)vinylene, and polyaniline-based materials.

The conductive polymer may include impurities to improve electric conductivity.

The organic-inorganic hybrid nanofiber may have a diameter of 10 nm to 100 nm.

Another aspect of the present invention provides a method of forming an organic-inorganic hybrid nanofiber, including: preparing an organic-inorganic composite solution by mixing an organic material, an inorganic material and a solvent; forming an oxide-polymer composite nanofiber by electrospinning the organic-inorganic composite solution; primarily annealing the formed oxide-polymer composite nanofiber and volatilizing the solvent; and secondarily annealing the solvent-free oxide-polymer composite nanofiber and forming an organic-inorganic hybrid nanofiber.

The preparation of the organic-inorganic composite solution may include measuring the organic material, the inorganic material, and the solvent in a predetermined weight ratio and mixing the components; and stirring the composite solution at room temperature or more.

The secondary annealing may be performed at a glass transition temperature of the organic material.

The organic-inorganic hybrid nanofiber may have a diameter of 10 to 100 nm.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a structural diagram of an organic-inorganic hybrid nanofiber according to an exemplary embodiment of the present invention;

FIG. 2 is an example of a flowchart illustrating a method of forming the organic-inorganic hybrid nanofiber according to the exemplary embodiment of the present invention; and

FIG. 3 is a structural diagram of a thermoelectric device including the organic-inorganic hybrid nanofiber according to the exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. For clarity, a part that is not related to the description of the present invention will be omitted, and similar part will be represented by a similar reference mark throughout the specification.

Throughout the specification, when a part “includes” or “comprises” a component, the part may include, not remove, another element, unless otherwise defined. In addition, the term “part” or “unit” used herein means a unit processing at least one function or operation.

Before the description of the present invention, first, the concept of a thermoelectric device as a basis of the present invention will be briefly described.

Thermoelectric energy conversion efficiency of a certain material depends greatly on a ZT (Figure-of-Merit) value of the material, which is expressed by the following Formula (1):

ZTₘ=α²σT/κ (1)

Here, α is a Seebeck coefficient, σ is electric conductivity, T is a temperature, κ is thermal conductivity, and the subscript m is a material.

The Seebeck coefficient α is also referred to as thermopower or thermoelectric power, which may have a negative or positive value, and corresponds to a material's native property as a coefficient expressed by a ratio of a change in voltage ΔV to a change in temperature ΔT (ΔV/ΔT). Generally, the Seebeck coefficient has a lower value in a metal and a higher value in a semiconductor.

The numerator of Formula (1) is related to a concentration of a carrier to usually raise the ZT value as a power factor, and a material having a carrier with high mobility is preferable to have high electric conductivity at the same concentration.

The thermoelectric device is not formed of one material. The device is completed using two types of materials, that is, n-type and p-type materials. Thus, a ZT value of only one material is not very significant. As a result, the ZT value of the device, unlike the ZT value of the material alone, is expressed by the following formula (2):

ZT_{d}=(αₚ²−αₙ²)T/[(Rₙκₙ)^{1/2}+(Rₚκₚ)^{1/2}] (2)

Here, the subscript d is a device, and R is an electric resistance.

Efficiency of the thermoelectric device is directly proportional to a ZT_{d} value. According to Formula (2), it is seen that when the p-type and n-type materials have a large difference in thermopower and low thermal conductivity and electric resistance, the high ZT value is obtained.

As seen from the formula, in order to have a high ZT value, most basically, the electric conductivity needs to be high, and the thermal conductivity needs to be low. A material having such properties needs to meet several conditions:

First, the most ideal material needs to be glassy such that it is difficult to move a phonon related to the thermal conductivity but have a crystalline structure with respect to an electron related to the electric conductivity.

Second, two carriers, that is, an electron and a hole, are present in the material, and depending on the characteristic of the n-type or p-type material, one will be a majority carrier, and the other will be a minority carrier. Accordingly, to minimize the effect of the minority carrier, a bandgap needs to be sufficiently wider (approximately 10 k_{B}T). Particularly, to be available at a high temperature, it is important to minimize the effect of the minority carrier.

Third, the material needs to have high thermal stability. In other words, when a temperature rises, for example, in thermal annealing, or operation is carried out for a long time at high temperature, the material needs to show a less decrease in performance due to atomic diffusion in the material and inter diffusion during the contact with an electrode.

Fourth, to raise the electric conductivity, the material needs to have a carrier having high mobility.

Fifth, since the thermal conductivity is composed of a part by an electron and a part by a phonon, the part by an electron is directly proportional to the electric conductivity according to a Wiedemann-Franz expression, and the part by a phonon has a lower value as a mean free path is decreased. Thus, it is necessary for the material to have high electric conductivity, not too high, and to have a low mean free path of the phonon. To meet such conditions, there are attempts to develop various thermoelectric materials and device structures.

Therefore, the present invention is to apply a material formed of a hybrid of an organic material or polymer having low thermal conductivity and a relatively higher electric conductivity than an insulator and an inorganic material having very high electric conductivity to have a nanofiber shape by electrospinning to a low-priced thermoelectric device having relatively high thermoelectric conversion efficiency.

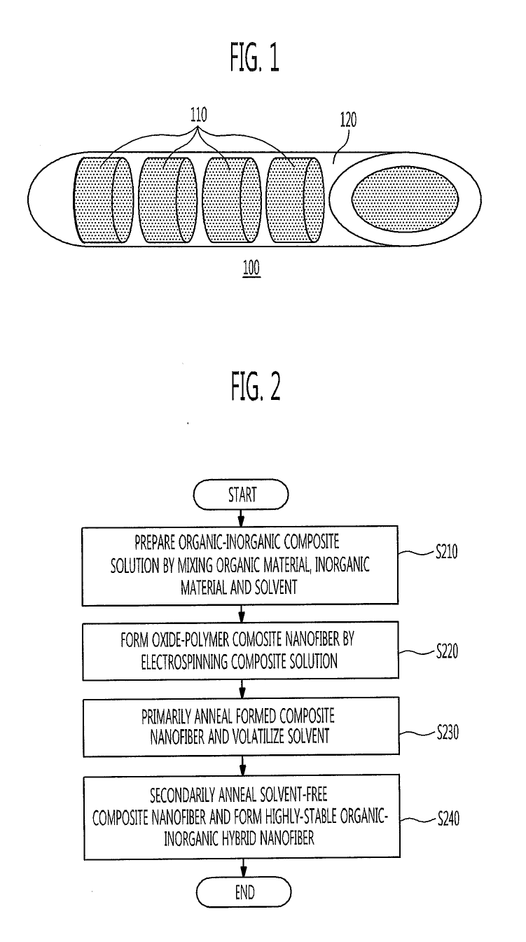

FIG. 1 is a structural diagram of an organic-inorganic hybrid nanofiber according to an exemplary embodiment of the present invention.

Referring to FIG. 1, the organic-inorganic hybrid nanofiber 100 according to the exemplary embodiment of the present invention includes an inorganic semiconductor material 110 and a conductive polymer 120.

The organic-inorganic hybrid nanofiber 100 according to the exemplary embodiment of the present invention has the inorganic semiconductor material 110 with high electric conductivity in the conductive polymer 120 with low thermal conductivity. In detail, the plurality of inorganic semiconductor materials 110 may be included in the conductive polymer 120, and the plurality of inorganic semiconductor materials 110 may be spaced a predetermined distance apart from each other in the conductive polymer 120.

As the inorganic semiconductor material 110, a particle or grain (nanoparticle or nanograin) formed of a semiconductor material such as a Bi or Sb-based alloy, SiGe, or Si, which is used as a conventional thermoelectric material, may be used.

The conductive polymer 120 has a very lower thermal conductivity than the inorganic semiconductor material 110, and a higher electric conductivity than an insulator, a general polymer. Hence, the conductive polymer 120 is suitable as a medium including the inorganic semiconductor material 110.

Since the inorganic semiconductor material 110 has higher electric conductivity and thermal conductivity than the conductive polymer 120, when the inorganic semiconductor material 110 is hybridized in the form of a composite material, the thermal conductivity may be significantly decreased, and the electric conductivity may be less decreased.

The conductive polymer 120 may be a polythiophene, poly(p-phenylene)vinylene, or polyaniline-based material.

Further, to improve the electric conductivity, the conductive polymer 120 may be a little doped.

According to the exemplary embodiment of the present invention, the organic-inorganic hybrid nanofiber includes the conductive polymer 120 and the inorganic semiconductor material 110, but it is just an exemplary description. The organic-inorganic hybrid nanofiber according to the exemplary embodiment of the present invention includes all kinds of organic-inorganic hybrid nanofibers having a thermoelectric property in the form of a nanofiber, which is formed by hybridizing an organic material or polymer having low thermal conductivity and a higher electric conductivity than an insulator as a medium with an inorganic material which can be present in the organic material in a nanoparticle or nanocrystal state.

Hereinafter, a method of forming the organic-inorganic hybrid nanofiber having the above described structure will be described.

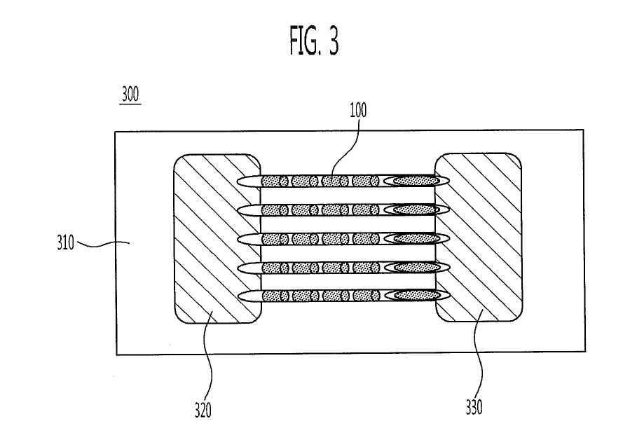

FIG. 2 is an example of a flowchart illustrating a method of forming an organic-inorganic hybrid nanofiber according to an exemplary embodiment of the present invention.

Referring to FIG. 2, an organic-inorganic composite solution is prepared by mixing an organic material, inorganic material, and a solvent (S210).

The organic-inorganic composite solution may be prepared by measuring an organic material (i.e., an organic medium), an inorganic material (e.g., an inorganic semiconductor material), and a the solvent in a predetermined weight ratio and mixing the components, and stirring the composite solution at room temperature (21 to 23° C.) or more for a long time. When the composite solution prepared as described above is used, a bead-free nanofiber may be formed.

Subsequently, an oxide-polymer composite nanofiber is formed by electrospinning the composite solution (S220).

The oxide-polymer composite nanofiber (i.e., the organic-inorganic hybrid composite nanofiber) may be formed by electrospinning the composite solution.

Afterwards, the formed oxide-polymer composite nanofiber is primarily annealed to volatilize the solvent (S230).

This operation is performed to form a composite nanofiber having thermal and physical stabilities and rigidities. To form a more stable and rigid composite nanofiber, the composite solution may be annealed around a boiling point of the solvent to completely volatilize the solvent.

Afterwards, the solvent-free composite nanofiber is secondarily annealed at high temperature, thereby forming a highly-stable organic-inorganic hybrid nanofiber (S240).

This operation is performed to evenly disperse the inorganic semiconductor material in the organic medium. To more evenly disperse the inorganic semiconductor material in the organic medium, annealing may be performed around a glass transition temperature of the organic material.

The formed organic-inorganic hybrid nanofiber may have a diameter of 10 to 100 nm.

FIG. 3 is a structural diagram of a thermoelectric device including an organic-inorganic hybrid nanofiber according to an exemplary embodiment of the present invention.

Referring to FIG. 3, the thermoelectric device 300 according the exemplary embodiment of the present invention includes an insulating substrate 310, a high temperature unit 320, a low temperature unit 330, and an organic-inorganic hybrid nanofiber 100.

As the organic-inorganic hybrid nanofiber 100 is formed on the insulating substrate 310 of the thermoelectric device 300, and particularly, the high temperature unit 320 and the low temperature unit 330 are connected to the organic-inorganic hybrid nanofiber 100, the thermoelectric device 300 having high thermoelectric conversion efficiency may be formed.

Although the organic-inorganic hybrid nanofiber according to the exemplary embodiment of the present invention may be applied to various fields, when it is applied to the thermoelectric device as shown in FIG. 3, its utility may be further increased.

Thus, it is apparent that a unit device of the thermoelectric device formed of such an organic-inorganic hybrid nanofiber, and a module of the thermoelectric device formed of the organic-inorganic hybrid nanofiber are also included in the scope of the exemplary embodiment of the present invention.

The organic-inorganic hybrid nanofiber for the thermoelectric device according to the exemplary embodiment of the present invention basically has high electric conductivity of the inorganic material, and low thermal conductivity of the organic material. Further, since the fiber has a nano-scale thickness, it may have an effect capable of reducing the thermal conductivity of the inorganic material. As the nanofiber is formed by a solvent process, it may be used as a thermoelectric material having advantages of low-temperature and low-priced process.

According to an organic-inorganic hybrid nanofiber and a method of forming the same of exemplary embodiments of the present invention, a thermoelectric device having excellent properties using a new nanofiber material formed of a hybrid or composite material of a highly-effective and low-priced single molecule organic material or polymer and an inorganic material can be produced.

Since the organic-inorganic hybrid or composite material nanofiber according to the exemplary embodiment of the present invention may retain high electric conductivity of an inorganic material but reduce thermal conductivity due to an arrangement structure such as a superlattice, it is suitable as a thermoelectric material. Further, the organic-inorganic hybrid or composite material nanofiber does not need annealing at high temperature, and thus can produce highly effective thermoelectric material in a low-priced process.

As a result, it is possible to realize a thermoelectric device having a high ZT (figure-of-merit) value, and particularly, it is advantageous in miniaturization. Therefore, the thermoelectric device which is suitable as a power source for an IT device requiring higher portability and longer durability can be produced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An organic-inorganic hybrid nanofiber, comprising:
an inorganic semiconductor material in a nanoparticle or nanocrystal state; and
a conductive polymer including the inorganic semiconductor material and having a lower thermal conductivity than the inorganic semiconductor material,
wherein the inorganic semiconductor material and the conductive polymer are arranged in a composite material type to have a thermoelectric property.

2. The nanofiber of claim 1, wherein the conductive polymer includes a plurality of the inorganic semiconductor materials, which are spaced apart from each other at a predetermined interval.

3. The nanofiber of claim 1, wherein the inorganic semiconductor material is selected from the group consisting of silicon (Si), silicon germanium (SiGe), bismuth (Bi) and antimony (Sb)-based alloys.

4. The nanofiber of claim 1, wherein the conductive polymer is selected from the group consisting of polythiophene, poly(p-phenylene)vinylene, and polyaniline-based materials.

5. The nanofiber of claim 1, wherein the conductive polymer includes impurities to improve electric conductivity.

6. The nanofiber of claim 1, which has a diameter of about 10 to 100 nm.

7. A method of forming an organic-inorganic hybrid nanofiber, comprising:
preparing an organic-inorganic composite solution by mixing an organic material, an inorganic material and a solvent;
forming an oxide-polymer composite nanofiber by electrospinning the organic-inorganic composite solution;
primarily annealing the formed oxide-polymer composite nanofiber and volatilizing the solvent; and
secondarily annealing the solvent-free oxide-polymer composite nanofiber and forming the organic-inorganic hybrid nanofiber.

8. The method of claim 7, wherein the preparation of the organic-inorganic composite solution comprises:
measuring the organic material, the inorganic material, and the solvent in a predetermined weight ratio and mixing the components; and
stirring the composite solution at room temperature or more.

9. The method of claim 7, wherein the secondary annealing is performed at a glass transition temperature of the organic material.

10. The method of claim 7, wherein the organic-inorganic hybrid nanofiber has a diameter of about 10 to 100 nm.
